(19) United States
(12) Patent Application Publication
(10) Pub. No.: US 2019/0027052 A1
(43) Pub. Date: Jan. 24, 2019

(54) DIGITAL HABIT-MAKING AND COACHING ECOSYSTEM

(71) Applicant: Wellcoaches Digital LLC, Wellesley, MA (US)

(72) Inventor: Margaret A. MOORE, Wellesley, MA (US)

(21) Appl. No.: 16/066,822

(22) PCT Filed: Jan. 3, 2017
(86) PCT No.: PCT/US17/12040

§ 371 Date: Jun. 28, 2018

Related U.S. Application Data
(60) Provisional application No. 62/274,599, filed on Jan. 4, 2016.

(51) Int. Cl. G09B 5/06; G09B 7/04

(52) U.S. Cl. CPC G09B 5/06; G09B 7/04

(57) ABSTRACT

An electronic system for facilitating the establishment of one or more habits, including: a) an electronically-stored library containing descriptions of multiple habits, b) a computer for searching the library, c) a screen for electronically displaying and selecting one or more of the habits, and d) a computer, which can be that of b) or a different computer, for assisting the user in the formation of a selected habit.

### BACKGROUND

Habit-making, albeit a complex process, is a ubiquitous human activity.

### SUMMARY OF THE INVENTION

The present invention provides computer-enabled systems and methods for facilitating the formation of desirable habits.

Thus in one aspect, the invention features an electronic system for facilitating the making of one or more desirable habits; the system includes: a) an electronically-stored library containing descriptions of multiple habits, b) a computer for searching the library, c) a screen for electronically displaying one or more habits that have been selected by a user from the library, and d) a computer, which may be the same as that of b) or which may be a different computer, for assisting a user in forming one or more selected habits.

The habits stored in the library may be divided into one or more categories. The library may be composed at least in part of a library accessible to the public, and which can be added to or altered by members of the public. The library may also be accessible to only one organization. The library may also include a personal sub-library of habits.

The system can be configured to facilitate habit formation which includes at least one of the steps of learning, experimenting, practicing, and sustaining, and can further include reflecting and social networking. In an embodiment, all four of these steps, learning, experimenting, practicing, and sustaining, can be employed. One or more, or all, of these steps can be enabled by computer-generated prompts. These prompts can be selected from, e.g., audio, graphic, photo, video, animation, voice, and music.

The system can employ a digital coach to facilitate the habit-making steps, which can (i) respond to user inquiries, (ii) ask questions and respond to user answers, (iii) offer suggestions, or (iv) all of (i), (ii), and (iii). The digital coach can employ graphics, photos, voice, animation, video, text messages, email messages, non-voice audio, an avatar, or music, or a combination thereof. The technology for computerized operation of digital assistants is well known; one patent example is U.S.P. 20140040748, owned by Apple Corporation, hereby incorporated by reference.

The digital coach and the user can communicate by voice, with the digital coach being programmed to recognize the user's requests and questions and to employ a recorded or computerized voice to respond to the user's requests and questions. The technology for enabling this embodiment is well-known; patent examples are U.S.P. 20140222436, owned by Apple Corporation, hereby incorporated by reference; and U.S. Pat. No. 9,009,033, owned by Nuance Corporation, hereby incorporated by reference.

A computer of the system can be programmed to allow the user to request that the digital coach search a Habits Library for a habit that addresses a concern of the user, such as procrastination; the system can allow the digital coach to convey to the user a name or description of the selected habit, and to allow the digital coach to instruct the user on one or more of the habit-making steps: learn, experiment, practice, and sustain. The learning step can include presentation of video.

The instruction provided by the digital coach can be carried out using audio or video, or both, and can include a motivator such as music or an avatar, which can talk, in recorded or computerized voice, or display written text.

A computer used in the system can be programmed to allow the digital coach to prompt the user to do one or more of: a) rate the selected habit (for example, on a 1-5 scale), b) decide how to proceed (stop, start, or continue) with respect to the selected habit, c) assess or change one or more motivators with respect to the selected habit, and d) assess the strength of the selected habit (for example, on a 1-5 scale).

A computer of the system can be programmed for machine learning, such that the system changes its prompts, requests, and question over time after interacting with the user regarding habit-making. Machine learning is described in the patent literature. In this embodiment, the digital coach can be programmed to apply behavior change techniques to the habit-making process. In employing behavior change techniques, the digital coach can ask the user, by voice or text, to do one or more of the following: a) complete assessments of habit-making boosters such as goals, motivation, confidence, strength, and social support; b) make suggestions based on the assessments of a); c) name a heartfelt intention or benefit of sustaining a particular habit to boost motivation and engagement; d) add user reflections to a digital journal on the process of making one or more desirable habits; and e) engage the user's strengths by asking one or more of the coaching questions: what am I curious about?; what would be a creative approach toward making a particular habit?; and how could I enhance my confidence in making a particular habit?

The system can have the capacity to aid multiple users in habit-making, and can have the capacity, in that case, to amass data from multiple users, including identification of habits worked on, success or lack thereof in particular habit formation steps or digital coaching input, and demographic information regarding the users. The system can have the computer-enabled capability to analyze the amassed data to assess the popularity or efficacy of various habit-making and digital coaching steps and strategies.

In a related aspect, the invention features a method for the making of one or more desirable habits by one or more users. The method includes: a) providing an electronically-stored library containing multiple desirable habits; b) providing a computer for searching the library, whereby the one or more users select one or more habits to work on; c) providing a digital coach to help users complete one or more habit—making steps; and d) at least one human coach to assist the one or more users in forming and/or sustaining the one or more selected habits.

In the method, the selected habits can be displayed on a screen; and the method further includes the step of matching multiple coaches to multiple users. The matching can be based on pre-determined criteria including demographic information about both the users and the coaches.

### DRAWINGS

The patent or application file contains at least one drawing executed in color. Copies of this patent or patent application publication with color drawing(s) will be provided by the Office upon request and payment of the necessary fee.

FIG. 1 is a diagrammatic representation of a Habits Library with Habits Categories and Work Habits Subcategories.

FIG. 2 is a diagrammatic representation of a Habit-Making Unit that changes color or color shade with each Habit-Making Step.

FIG. 3 is a diagrammatic representation of a Personal Habits Library and Dashboard with Habits in each Habit-Making Step.

FIG. 4 is a Calendar with Scheduled Habits and a Habit Scheduler for a Habit Experiment.

FIG. 5 is a representation of a Digital Coach Avatar displayed on a watch and phone.

### DETAILED DESCRIPTION

The invention employs electronic devices to deliver a Habit-Making Ecosystem, in a way analogous to the iTunes® and YouTube® platforms: universal ecosystems for diverse and ubiquitous behaviors with wide-scale appeal and engagement. The inventor has incorporated principles and practices of coaching psychology and coaching science such that the Habit-Making Ecosystem may include a digital coach which over time helps a user complete habit-making steps and/or teaches a user how to self-coach with or without electronic devices.

The invention features a Habit-Making Ecosystem, which employs a large and universal library of Habit-Making Units, each of which guides a user through a simple, self-directed or digital-coach assisted process to:
a) learn about a potential new habit,
b) experiment and assess the habit's personal potential,
c) practice the habit and assess its strength, e.g. level and pace of automaticity, and worthiness of ongoing investment in further practice, and
d) determine when a habit has become automatic and has a risk of lapse, or not, or no longer requires digital reinforcement.

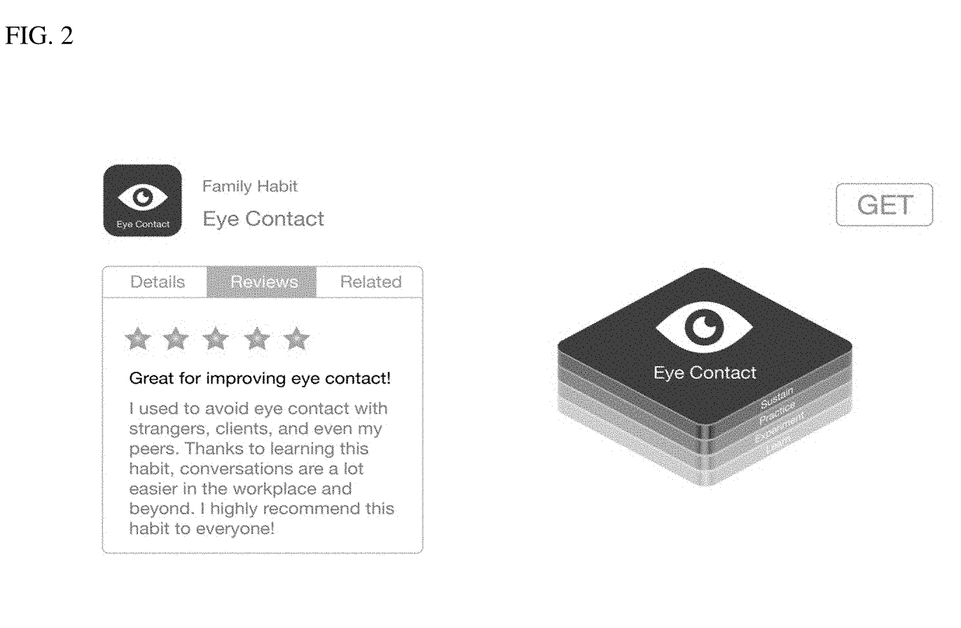

FIG. 2 is a diagrammatic representation of a Habit-Making Unit. In the illustrated Unit, a family habit, the making of eye contact, consists of the four steps shown (learn, experiment, practice, sustain), each of which is represented by a different shade. Also shown is a review by a user, giving this habit five stars (excellent) out of five.

For purposes of this description, a habit is considered to be a repeated and increasingly automatic practice that is sustained over time. A habit can be a mental process such as noticing and naming a negative emotion in order to reduce stress in a demanding moment, or a relational behavior such as making warm eye contact (FIG. 2) during conversation in order to improve a relational connection, or a lifestyle behavior such as eating an ounce of walnuts as a late afternoon snack to reduce heart disease risk. Habit-Making Units may be organized in life and work categories and subcategories, such as mind, health, life, finances, work, leadership, coaching others, self-coaching, creativity, procrastination avoidance, cooking, or relationships. Habit-Making Units may be adapted for users of different demographics.

### Electronic Device with Dashboard and Library

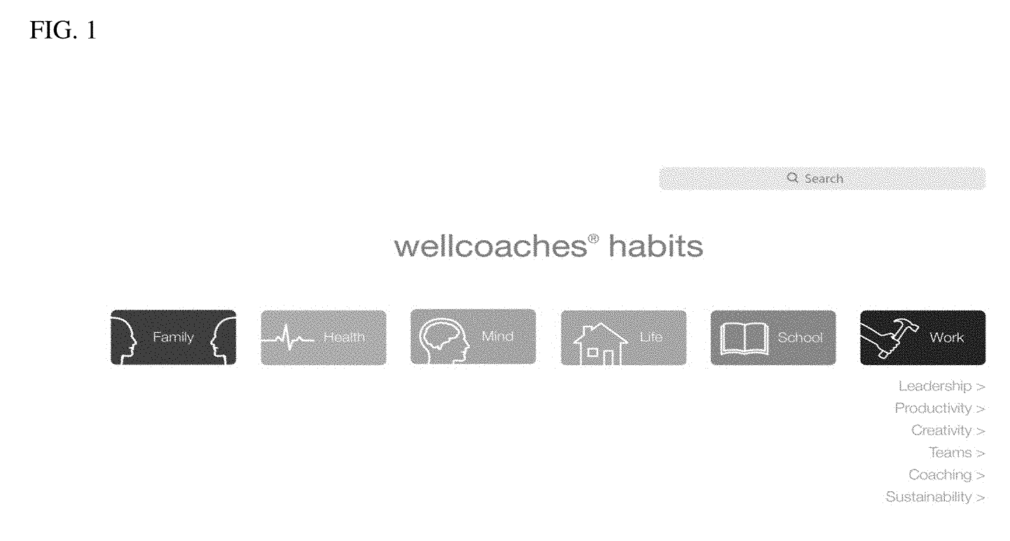

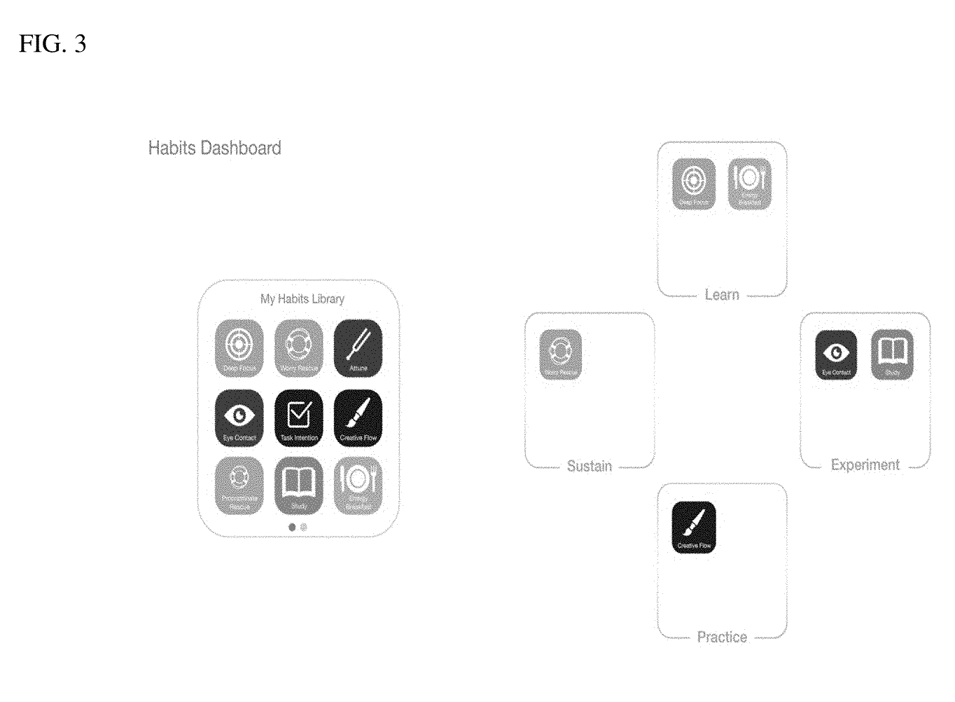

An electronic device of the invention has or is in communication with a public and/or personal Habit-Making Library, as is shown diagrammatically in FIG. 1. In the Library of FIG. 1, six categories of habits are shown: health, mind, life, relational (e.g., family), school, and work. As is also shown in FIG. 1, the ‘work’ category has five subcategories: leadership, productivity, creativity, teams, and coaching. The device is also in communication with a personal Dashboard which allows the user to search for potential habits and habit categories of interest, learn about top-rated habits among users, create do-it-yourself Habit-Making Units, and connect with users who share habit-making interests such as demographics, life, professional and health concerns. FIG. 3 is a diagrammatic representation of a Dashboard on which are displayed four habits (deep focus, eye contact, creative flow, and worry rescue), each paired with a different step in the habit-making process (learn, experiment, practice, and sustain). FIG. 3 also shows, again, a representation of a Habits Library, with categories mind (habits deep focus and worry rescue), relational (habits attune and eye contact), and work (habits task intention, creative flow, and procrastinate rescue).

The Habit-Making Library and Dashboard are provided on or associated with the electronic device, which can be an electronic interface device, such as a computer, tablet, phone, watch, robot, TV, a wearable device, or an electronic game device. The device has:
1) A Habit-Making Ecosystem with a public library of Habit-Making Units organized by category, such as mind, health, coaching, leadership, work, family, or financial habits, and subcategories of such, or playlists or groups of Habit-Making Units focused on a topic, such as procrastination, or mindfulness, or cravings, or bedtime preparation.
2) Habit-Making Units, which may follow a standardized template that guides a user through a series of steps from initial learning and exploration, to experiments, to practice, to establishment, to maintenance, and re-establishment after a relapse with respect to a particular habit.
3) Habit-Making Units guide users through a habit making process including a) selecting potential habit(s) or habit category(s), b) learning about the habit's appeal and potential through audio, visual, written, verbal, or social resources, c) experimenting with a habit using motivational cues or notifications through calendar or device software, which can be of an audio, visual, verbal, or social nature, assessing a habit's potential for personal benefits and automaticity, d) practicing a habit using prompts and reminders including audio, visual, verbal, or social resources, e) assessing the habit's strength, its rate and level of automaticity, as well as personal benefits and return on investment in habit practice, and f) eventually designating a habit as “made” or established, no longer requiring digital nudges and prompts, at least for now until a lapse or relapse may prompt a return to habit-making practice.
4) Individual Habit-Making Units, groups, playlists, or courses of multiple Habit-Making Units, are made available in the ecosystem to users at no charge, or for a one-time fee, or subscription.
5) Software that connects a habit-making event such as an experiment, practice, or assessment with user-scheduled or software-prompted voice, music, sound, visual, photo, graphic or text notifications or calendar events.
6) An ecosystem of Habit-Making Units to which Habit-Making Unit creators such as authors, professional speakers, trainers or coaches, organizational managers or leaders, religious or spiritual leaders, healthcare providers, teachers, parents, or users can contribute by building and uploading their customized Habit-Making Units or groups of Units, and make available to interested users or groups of users for free or for sale.
7) A do-it-yourself Habit-Making Unit kit for individuals who want to design and build their own Habit-Making Units, unit “playlists” or courses.
8) A Forum in which a social community of habit-makers can share and read habit-unit ratings, solicit and give advice, team up in pairs or in a group for support and peer coaching, challenge or compete against other groups.
9) A digital coach which applies machine learning and artificial intelligence and communicates by audio, voice, visual, video, or verbal message to nudge, prompt, coach a user, or respond to a user request for any step of the habit-making process, e.g. to find a potential new habit, to experiment with or practice a new habit, to sustain a habit, to schedule a habit experiment or practice, or re-establish a lapsed habit, or apply any other behavior change technique that may improve habit-making such as journaling, tracking, mindset, and social support.
10) A digital coach which applies machine learning to respond to a user physiological parameter, or a user request for help in dealing with life challenges and events, such as overwhelm, stress, conflict, temptation, tiredness, emotional hijack, or creative problem-solving. The digital coach response uses coaching and behavior change techniques, including encouragement, suggestions of potential habits to test, and accountability reminders.

### Keyboard, Screen, and Physiological Parameters

The device can include a keyboard and a screen, such as a touchscreen, and the habit-making ecosystem, Dashboard, or Habit-Making Unit can be displayed visually on the screen. The user can select categories of interest within the ecosystem and can navigate through various portals.

The device can include sensors for physically measuring a physiological parameter of the user, e.g., EEG, heart rate, heart rate variability, blood sugar or blood pressure, that may vary with one or more physical or emotional states, or brain performance or health; in this instance, the device includes an output component for conveying to the user recommended Habit-Making Units. The output component can be audible, visual, graphic, or text cues.

### Programmed Aids

The device can be programmed to aid the user in practicing a selected desirable habit by i) conveying to the user prompts, at pre-determined intervals, or based on geographic or personal metric triggers, to practice the habit, ii) tracking the practicing of the selected habit, iii) tracking the rewards flowing from the practicing of the selected habit, and iv) using the tracking of step iii) to calculate the degree to which the habit becomes automatic.

The device can be programmed to receive and store a goal of the user, attainment of which is aided by one or more Habit-Making Units.

The electronic device can be programmed to provide visual or audible prompts to the user, the prompts occurring either: a) randomly throughout the day, or b) at predetermined times throughout the day, c) at particular geographic locations, wherein the prompts convey to the user a potential habit to engage in.

The electronic device can include speech recognition software such that a user can speak to the device regarding an activity or task, e.g., “I'm going to spend the next 30 minutes on email processing”, and the device will, in response, convey to the user one or more helpful habits, e.g., “Take a moment with each email to honor the email sender's positive intention, to energize personal purpose and support efficient and effective email processing.”

Any of the above may be performed in a data processing system or by a data processing method, e.g., instructional steps carried out by a computer, processor, etc. To illustrate, a diagrammatic system may include, for example, one or more of the following: a processor, a main memory, a static memory, a bus, a video display, an alpha-numeric input device, a cursor control device, a drive unit, a signal generation device, a network interface device, a machine readable medium, instructions and a network. The diagrammatic system may include a personal computer, a handheld device, and/or a data processing system in which one or more operations disclosed herein may be performed. The processor may be a microprocessor, a state machine, an application-specific integrated circuit, a field programmable gate array, etc. The main memory may be a dynamic random access memory and/or a primary memory of a computer system. The static memory may be a hard drive, a flash drive, and/or other memory information associated with the data processing system. The bus may be an interconnection between various circuits and/or structures of the data processing system. The video display may provide graphical representation of information on the data processing system. The alpha-numeric input device may be a keypad (actual or virtual), a keyboard and/or any other input device of text. The cursor control device may be a pointing device such as a mouse, a scroll-wheel, or a virtual pointer. The drive unit may be a hard drive, a storage system, and/or other longer term storage subsystem. The signal generation device may be a bios and/or a functional operating system of the data processing system. The network interface device may be a device that may perform interface functions such as code conversion, protocol conversion and/or buffering required for communication to and from the network. The machine readable medium may provide instructions on which any of the methods disclosed herein may be performed. The instructions may provide source code and/or data code to the processor to enable any one/or more operations disclosed herein. In all of the above, the components may provide non-transitory signal transmission, or be embodied in a non-transitory tangible media.

The device may be enabled and operated using hardware circuitry, e.g., CMOS based logic circuitry, firmware, software and/or any combination of hardware, firmware, and/or software, e.g., embodied in a non-transitory machine readable medium.

The device can include an element for storing data, e.g., a data storage element, which is present on an external device, such as a bedside monitor, PDA, smart phone, tablet, robot, computer server, etc. Typically, the data storage element is a non-transitory computer readable medium. The term “computer readable medium” refers to any storage or transmission medium that participates in providing instructions and/or data to a computer for execution and/or processing. Examples of storage media include CD-ROM, a hard disk drive, a flash drive (e.g., a USB flash drive), a ROM or integrated circuit, a magneto-optical disk, or a computer readable card such as a PCMCIA card and the like, whether or not such devices are internal or external to the computer.

### Habit-Making Ecosystem

The habit-making electronic ecosystem of the invention makes use of principles of many scientific domains, including psychology, neuroscience, coaching psychology, positive psychology, therapy, coaching science, self-coaching, self-science, and behavior change psychology and technology.

As is discussed above, a Habit-Making Ecosystem according to the invention includes a Library and a personal Dashboard (a personal library of downloads from a library) of Habit-Making Units organized by categories such as mind, health, coaching, leadership, work, family, or finances, and subcategories of such, or groups or collections or courses of Habit-Making Units focused on a narrow topic such as procrastination, or cravings, or bedtime preparation, or mindfulness routines.

1. Habit-Making Library and Dashboard

A user visits a public or an organization's habit Library, or uses his or her own purchased or free Library and selects Habit-Making Units from the library to build a personal Habit-Making Library. He or she then selects Habit-Making Units to populate a personal Dashboard that allows the user to follow various steps of a habit-making process. A user may move Habit-Making Units into different areas of the Dashboard. Each area relates to a particular step in the habit-making process. Dashboard areas can include a Library area (archiving habits under consideration by priority and timing of interest, such as—habits for future investigation, rejected or discontinued habits, or habits on hold, as well as habits well established with low risk of lapse), a Learning area, an Experiment area, a Practice area, and a Sustain or Lapse Prevention area for habits that are becoming automatic and no longer need significant digital support and yet are at risk for lapse and would benefit from check-ins. The user's personal Habit-Making Unit library can be searched by various categories including Habit-Making Unit type, date of download, or origin (goal search, category search, digital or digital coach prompt, help request to device, social recommendation). The Library can display a summary showing how many habits are in the user's Library, and display priority and stage of habit-making.

2. Habit-Making Unit

A Habit-Making Unit is made up of self-paced steps of a habit-making process in a single, layered digital unit which enables one or more of (and is not limited to) learning, experimenting, practicing, sustaining or lapse prevention, and archive, as well as access to a habit's social aspects, including ratings and comments from other users, and a habit users' journal or reflections on a habit or habit-making steps.

a) Learning Step

A Habit-Making Unit has a learning step which includes a learning intervention (e.g., listening to an audio, watching a video or animation, reading an article, reflecting by typing in a journal or dictating into text, reading and participating in a community discussion) to gain knowledge on the what, why, how, and when considerations for a particular habit. One learning strategy is to learn more about the benefits of a particular habit in order to inspire and improve a user's interest and motivation. For example, a two-minute video on a habit of “eye contact in conversation” would define eye contact, describing the “what,” then exploring the “why,” why eye contact improves a relational connection, followed by the “how” with instructions, and then “when” eye contact is most valuable.

b) Experimenting Step

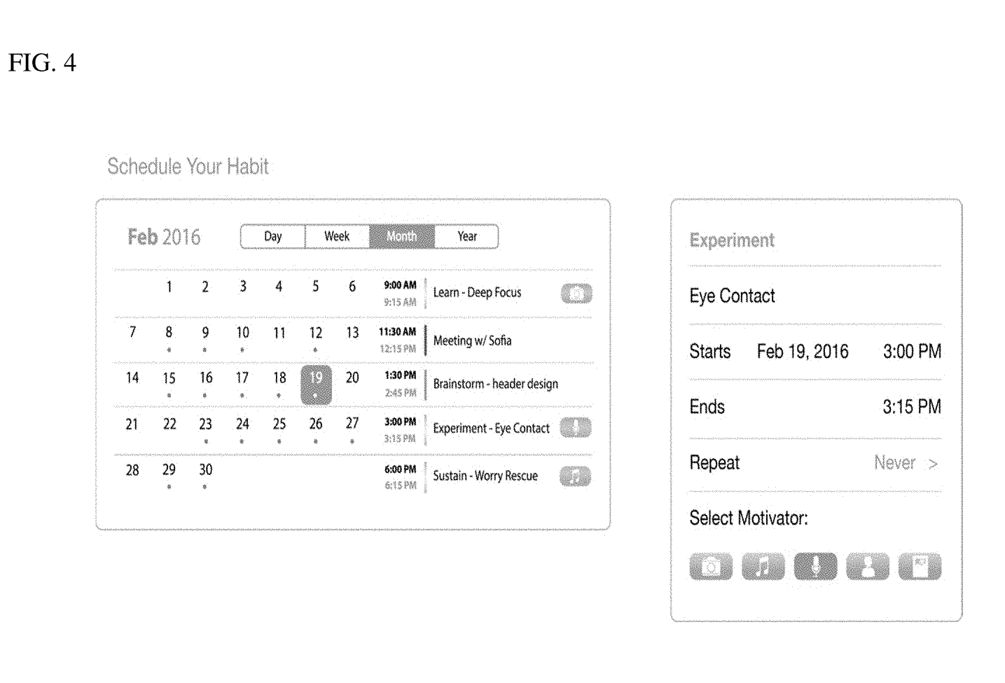

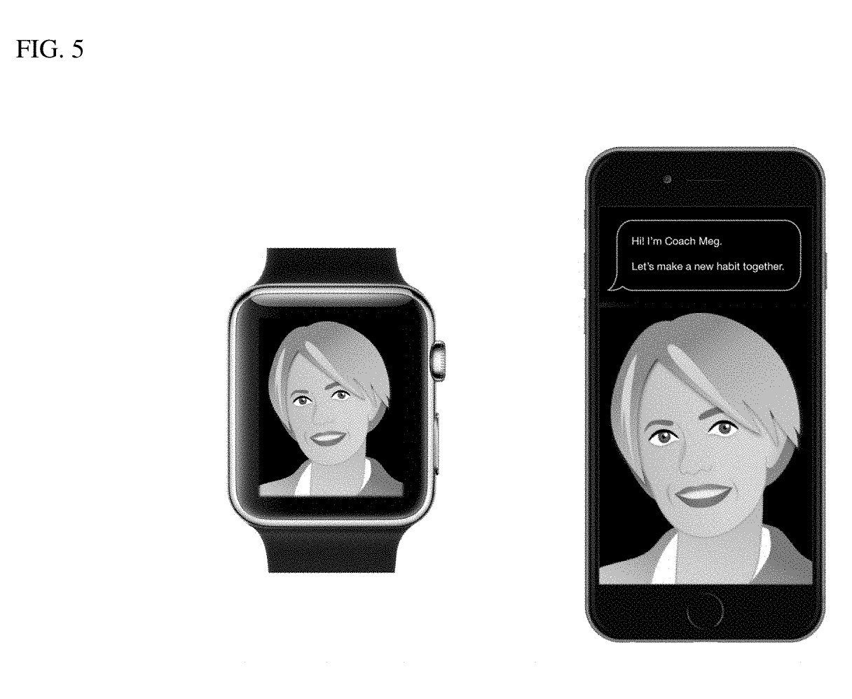

After the learning step, a user may decide to experiment with a new potential habit. The Habit-Making Unit is moved by the user or digital coach to the Experiment area in the user's Habit-Making Dashboard. The Habit-Making Unit or the digital coach may prompt the user to schedule a habit experiment prompt or reminder as a digital notification, digital coach notification, calendar event notification, or add to an existing calendar event, or device wallpaper, such that the user is prompted effectively to perform a habit experiment at a certain time on a certain date, or for a day or more. A screen-displayed calendar with scheduled habits, and a habit scheduler are shown in FIG. 4. Motivating prompts are also shown in FIG. 4. One effective prompt is text or voice from a digital coach avatar (FIG. 5).

Alternatively, the schedule can be simply “on-demand” to be acted upon when a user has a need at random times, such as a moment of overwhelm or anxiety. The habit prompt or reminder may include a visual, such as a photo, graphic or icon, an audio voice or other sound, animation, video, or text, and may be customized and changed as often as needed by a user or a digital coach for optimal impact. The user may be prompted by the software including a digital coach to confirm whether the habit experiment was completed, attractive to be repeated, or needs to be rescheduled or cancelled. The user may also be prompted to assess the experiment, including the user's level of motivation and confidence, and can include a request for a star rating of interest, for example a rating scale where the best rating has five stars. The user may also be prompted by the software or a digital coach to repeat the experiment, or decide to proceed to the practice step, or reject the habit, or delay habit-making, and return the habit to the user's Library.

c) Practice Step

If a user decides to proceed to the practice step, after a successful experiment, or directly from the learning step, the user then selects or is prompted to select by the software or a digital coach habit practice parameters—how (notification, calendar event, geographic location, device wallpaper, or on-demand, type of prompt, e.g. visual or voice/audio or vibrate), and when (day, time, frequency, stop date). When the prompt is received, the user may elect to complete, skip, or reschedule practice. After an episode of habit practice is done, the user is asked by the software or a digital coach to assess the habit strength, including motivation, confidence, and level of automaticity. The user may also stop the habit practice at any time, rejecting it as a poor investment or bad timing in habit-making, or determining that the habit is established and doesn't need further digital coaching but is still at risk of lapse and stays on the dashboard in the sustain area, or is established and at low risk for relapse and is moved to the user's Library. Or, the habit can be rejected, or put on hold, and also categorized and archived in the user's Library.

d) Sustain Step

The user may decide to assign a habit to the Sustain step, when regular scheduling and cues are not needed, and yet the habit has some risk of lapse. The user can schedule less frequent reminder, perhaps a weekly, monthly, quarterly, or yearly check-in with a prompt and reminder accompanied by provocative cue such as a visual, icon, animation, video, voice, or text. The user can assess lapse risk and schedule the next check-in as needed.

e) Other Steps

User community ratings and comments may also be accessed in a Habit-Making Unit. A user journal may be included to record user's reflections on insights and learning, motivational benefits and confidence challenges of a particular habit. Tracking of habit experiment and practice assessment scores can be presented in graphical form and compared with assessments of other users, who in turn can share their scores.

3. Habit-Making Guidelines

The Habit-Making Ecoystem can include guidelines and instructions delivered by the software or digital coach to help users use the ecosystem wisely, for instance limiting a habit-making step to two or three Habit-Making Units at one time, and aiming to establish no more than 2-3 new habits every three months or so. Over a year or so, a user may establish a habit portfolio of five or more habits in a category, which all together improve a user's health, quality of life, well-being, performance, or leadership in a significant and noticeable fashion, and deliver a good return on the investment in habit-making.

4. User Search of Habit-Making Units

a. User Search by Goal Input

User may enter goals for personal or professional improvement in the public library of the Habit-Making Ecosystem and get rated suggestions of potential Habit-Making Units or groups of Habit-Making Units.

b. User Search of Habit-Making Type

User may search the Habit-Making Ecosystem for habit categories or subcategories of particular interest such as procrastination, creativity, diabetes-healthy breakfasts, craving surfing, or bedtime preparation, team leadership, or parenting two-year olds, and get rated suggestions of potential Habit-Making Units or groups or courses of Habit-Making Units.

c. User Request of Device's Digital Coach

User may seek help from a device, serving as a digital coach, via voice recognition software or text for habit-making suggestions. A device may employ artificial intelligence including domains such as machine-learning, language processing, and affective computing to interpret a user request such as, “I need help, I am overwhelmed.” Then the device's digital coach may suggest Habit-Making Units that are highly rated by other users for dealing with overwhelm, or customized for user's circumstances, such as age or other demographics.

A user may ask a device's digital coach (e.g., voice recognition software or text) for help with the habit-making process at any time, for example, asking to be reminded to find new Habit-Making Units, schedule learning, experiments, or practice, or searching the library for a hot new Habit-Making Unit that the user read about online. “Hello (digital) Coach Meg, would you help me practice a new creativity habit this afternoon? I need to be creative in dealing with a challenging project at 3 o'clock,” says Joe. (digital) Coach Meg replies, “Sure Joe, I'll remind you to use the divergent thinking habit you just learned about . . . ”

At decision points (e.g. ordering from a menu, selecting from a vending machine, selecting next task), user may seek help from the device's digital coach, to prompt engagement in digital coach-recommended habits aligned with goals, including health, performance, or relationship goals, rather than distractions, impulses, or cravings.

In moments of emotional hijack, impulses, cravings, or distractions, user may seek help from the device's digital coach to prompt engagement in certain digital coach-recommended habits, e.g., to enable a shift from a reactive to a proactive mind state and conscious control of next steps.

In moments of self-reflection, user may seek help from a device's digital coach to prompt engagement in certain habits to assist in exploring and decoding the messages of emotional states in order to better understand and manage psychological states such as unmet needs, thwarted values, underutilized or underappreciated capacities, or neglected drives.

In social situations, which can disrupt positive habits, user may seek help from a device's digital coach to prompt engagement in certain habits to assist in staying on track.

When adverse events or crises occur, such as external criticism, a health challenge, family illness, or a car breakdown, user may seek help from a device's digital coach to prompt engagement in certain habits which improve coping and resilience.

When user is struggling to meet personal or professional goals, user may seek help from a device's digital coach to prompt practice of habits that improve persistence and perseverance.

a. Digital Coach Prompt of User

User may be prompted by a device's digital coach by audio voice, animated digital coach avatar, text, or vibration to consider potential habits to explore based upon user's selection or searching on topics of life improvement, geographical location, calendar event, time of day, week, month, year, or seasonal event, or physiological measure such as heart rate or heart rate variability.

Calendar items or alerts, or time alerts, or geographical locations, random or scheduled, may prompt the measurement of user's physical states by self-report or by physiological measures, which can generate digital coach prompts for habits including exercise, brain foods, hydration, sleep, and brain breaks.

Calendar items or alerts, or time alerts, random or scheduled, to assess emotional states by self-report or physiological measures may generate digital coach prompts to user to practice certain habits, such as noticing and naming emotional states, or activating self-compassion or curiosity neural networks, or engaging in social activities, or play/fun activities.

For calendar activities or geographical locations or user parameters that require self-coaching, or when user seeks help from a device's digital coach, the digital coach may prompt user to engage in a series of self-coaching habits that support learning, change, and growth such as self-reflection, self-awareness, envisioning, insight, motivation, confidence, curiosity, autonomy, self-compassion, and purpose.

For calendar activities or geographical locations or user parameters that involve coaching others, or when user seeks help from the device's digital coach, the digital coach may prompt user to engage in a series of coaching habits which elicit in others various mindsets that support learning, change, and growth, such as self-reflection, self-awareness, envisioning, insight, motivation, confidence, curiosity, autonomy, self-compassion, gratitude and purpose.

For calendar activities or geographical locations or user parameters, or when user seeks help from a device's digital coach, the digital coach prompts user to engage in a series of self-leadership and leadership habits that support optimal performance in self and others, including other-focused, open-minded, and deep listening habits.

5. User Selection of Habit-Making Unit

User selects and downloads, from the Habit-Making Ecosystem Library (and purchases if there is a fee or other restriction on content access), one or more Habit-Making Units, which then appear in the user's Library and Dashboard.

6. Optimal Habit Portfolio

A user or group of users can use the Habit-Making Ecosystem to develop a new habit portfolio. The development of an optimal habit portfolio can be done by an individual, family, team, or organization.

7. Optimal Life or Work Structure

A user or group of users can use the Habit-Making Ecosystem to re-engineer a new life or work structure or team culture, optimizing a mix of habits each day, week, month, or beyond. The use of the Habit-Making Ecosystem to re-engineer an optimal life or work structure can be done by an individual, family, team, or organization.

8. Optimal Health & Well-being

A user or group of users can use the Habit-Making Ecosystem to improve brain health, and general health and well-being by optimizing a mix of habits. Brain performance and health may be continually evaluated via self-report measures, such as energy, or physiological measures that correlate with brain health, and general health and well-being, for example EEG, heart rate variability or blood pressure, as inputs for a mix of habits which improves health and well-being. The use of the Habit-Making Ecosystem to improve brain health, and general health and wellbeing, can be done by an individual, family, team, or organization.

9. Optimal Work Flow

A team, department, or organization can use the Habit-Making Ecosystem to re-engineer work flow habits. Work flow can be customized for different job types, such as traders on a stock trading floor, a surgical team in an operating room, engineers on a software or device development team, collaborative team of researchers, or a team in charge of manufacturing, customer service, distribution, accounting, or human resources.

10. Optimal Innovation

A team, department, or organization can use the Habit-Making Ecosystem to upgrade innovation—the capacity, quality, speed, and delivery of innovation. Tests of various combinations of habits and strategies, and habit series, deployed over time, can lead to a work flow design which improves innovation in degree, quality, and pace.

For example, new combinations and series of habits, in a day, week, month or over time, may improve the innovation process by generating more novel ideas, bigger advances or larger leaps from today's constructs, or more effective translation of ideas into testable prototypes, or a more creative refinement and implementation phase.

Next are five examples of individual applications of the invention.

### Example 1: Physician Wants Better Patient Relationships

Joan is a physician who is feeling highly distracted by the burden of completing electronic medical records for every 15-minute patient visit. Joan decides to invest in habit-making to improve relational connections to her patients in the shortened time now available. Her colleague from a local medical association recommended a course called Patient Coaching Habits that he finds valuable. The course includes a set of 12 Habit-Making Units to select from. Joan buys the course and downloads it to her personal Habit-Making Library, which already contains ten habits she has downloaded to improve sleep.

She wants to get a good sense of all of the 12 potential habits before she starts any habit experiments. She moves all 12 into the Learn step on her Dashboard and schedules a reminder at 8 pm the next Monday evening. As scheduled, at 8 am, Joan's digital watch lights up with the digital coach avatar which says “Hey Joan, time for the Learn step for your Patient Coaching Habits.” Joan smiles at the appealing avatar, finishes up after-dinner clean-up, and then in her over-achiever fashion, she devotes about 90 minutes to watching the 3-minute habit videos (the learning mode in the Learn step that she selected) for all 12 habits. Most of the videos are engaging and humorous, and cite scientific references, some of which she investigates quickly using the provided web links.

After the Learning step, Joan selects four habits to move to the Experiment step. One is called “Rapport” and concerns activating a brain state she has learned about for rapport where she shifts her mind out of her prefrontal cortex (forehead) which is thinking about diagnosis and medication issues, into her heart area as she takes two deep breaths. Then she syncs her heart up with her patient's heart as she warmly welcomes her patient to her office.

The next selected habit is “Listen” which provides guidance on how to listen to her patient with the purpose of understanding rather than thinking about what she will say next.

The third selected habit is “Empathetic Reflection,” which directs Joan to reflect back and summarize, to the patient with a warm voice, an account of what the patient is thinking and feeling, as expressed to Joan.

The fourth selected habit is “Co-Create,” which teaches Joan how to collaborate and co-create next steps with her patient, rather than giving instructions, while making sure that the patient's motivation and confidence are a little higher than at the start of the visit.

Joan schedules habit experiments for the next four weeks. She experiments with one habit per week, testing a habit daily for five days, a manageable pace. She is enjoying the simple calendar scheduling where Digital Coach Meg engages her via voice dialogue to set up a calendar notification on her digital watch with engaging, animated visuals five minutes before the first patient visit of the morning and afternoon, to prompt her to do experiments with each habit. When the habit experiment event and animated cue pops up on her digital watch or smartphone, she takes 5 seconds to look at the animation. At the end of each week, she gives each of the four habits the top 5-star rating; the instructions are easy to follow and the animated cue she selected (she didn't choose the photos or the digital coach voice) make her smile and engage rather than ignore the prompt. She decides that all four habits merit entering the habit Practice step.

Joan instructs Digital Coach Meg to move the four habits into the Practice step on her Dashboard. Joan links all four habits together as a habit string in one calendar alert before her first patient of the day so that she is primed to practice all four together. When the alert comes up it shows her four animated visuals (one per habit) in sequence, which primes her in ten seconds to engage each habit quickly and deeply. She is amazed how she is able to quickly integrate these four new habits into short patient visits. Immediately, she notices that her patients leave with a smile and gratitude for their connection and Joan's complete dedication to their interests even for a short few moments.

For three weeks Joan continues with the morning calendar alert and animated visual cue of all four habits. Then she decides that she can continue these new habits without the digital support. She asks Digital Coach Meg to move the four habits into the Sustain step for another two months and send a monthly reminder to make sure that she is still engaged. After the second month one evening she calls up Digital Coach Meg to request moving the four habits back to the Learning step in her dashboard, reviewing the habit videos again, and reading user comments and ratings. Her appreciation of the value of the four habits is deepened and she adds a user comment to encourage others to experiment with these four habits.

One day Joan visits the public habits library and browses through the Family category. In the Relationships subcategory, she is delighted to find a Coaching Habits course for families. She is inspired to propose that her husband and two teenage kids try it out as a way to improve family connection and communication. They download it together one rainy Sunday afternoon. The kids like that they can choose among 15 habits and not just do the same ones their mom chose. Joan doesn't exactly know what habits her husband and kids are working on, but notices a month later that her family is having more fun and laughing more together as they become more connected, empathetic, and better listeners and collaborators.

### Example 2: Lawyer Wants to Overcome Procrastination

Mike is a young lawyer committed to improving his work efficiency and quality. He struggles with procrastination, a lifelong challenge, particularly for tasks that he considers rather boring like completing his weekly timesheets, which are essential for the law firm's billing process. He paid penalties over the past year because of his procrastination, which is somewhat distressing as his boss never misses a deadline and is rather impatient with Mike's lack of timeliness. He confides in his sister who has a similar challenge with procrastination, and she notes enthusiastically that she has established some new procrastination prevention habits that he might want to try. Mike finds Coach Meg's course on procrastination, which has 12 procrastination-preventing habits, buys it and downloads it into his personal habits Library.

Mike selects two habits to move into the Learn step in his Dashboard: 1. Start the day by doing a creative and enjoyable task, so that you are more willing to do a boring task later in the day; you'll feel better, having started with something creative; 2. Break down dull tasks into small bite-size pieces.

Late one evening that week, Mike watches the learn portion of the two videos. He is fascinated to learn that he might not be meeting his needs for creative flow activity every day, which then triggers procrastination with respect to his non-creative activities; basically, the creative part of his psyche is sabotaging the internal organizer.

Mike decides to first focus on experimenting with a morning episode of creative flow where he spends an hour focused on the most creative project on his plate right now. He shuts down all wireless connections so that he enters and sustains a deep and satisfying flow state. After the first experiment, he moves the creative flow habit directly into the Practice step phase, with a calendar reminder, a text message on his phone, at the end of each work day to schedule his flow activity in the morning. Within a week he notes with interest in the habit's journal that the struggle to complete boring timesheets is less potent, although he does still get distracted quickly by more interesting activities.

The second habit Mike engages is to schedule no more than ten minutes at a time, once a day, for boring activities. He starts the ten-minute episodes by stating to himself his intention for the episode, to stay on top of his timesheets because it is good for his career, in order to fire up his motivation. After two experiments two days in a row he realizes that so long as he declares his intention and keeps the time spent on the boring activity to ten minutes, he can focus on the timesheets deeply and amazingly get a lot done, especially appreciating the value to his career and knowing that it will be over soon. He then experiments for the second time with another procrastination-preventing habit, which is an assessment of his procrastination. Mike notices that his self-rating has improved three of ten points. Pretty good progress, and lots more procrastination beating habits to try.

One late evening when he can't sleep, he activates his phone's digital coach and says—“Coach Meg, would you suggest bedtime habits that would help me sleep better?” Digital Coach Meg replies: “Hey Mike—I checked out the Habit-Making library for habits that work for other men your age and stage. The top-ranked habit is a yoga habit, two yoga poses for 6 minutes before you go to bed. Would you like to try it out?” Mike replies, yes. Digital Coach Meg buys (charging his securely uploaded credit card) and downloads the Habit-Making Unit for him and he finds it in his personal habits library on his smartphone a few minutes later. Ten minutes later he has completed the learning step, inspired by how the yoga poses stretch out the middle of the spine where stress accumulates over the day. As instructed, he creates a makeshift yoga block (firm pillow folded over twice) and completes the two poses in six minutes. He feels calmer and sleepier already. The next morning digital Coach Meg pings him on his way to work and asks whether he wants to try the habit again tonight. Mike says yes, and repeats it when Digital Coach Meg pings him a reminder at bedtime. He repeats the habit experiment for three more nights, giving it a 5-star rating. One night he awoke at 3 am and did the yoga poses again, which helped him get back to sleep. Then Coach Meg asks him whether he wants to purchase a yoga block ($15), and it will arrive at his home in three days. Mike says yes and Coach Meg texts the link with the order form. That night he moves the Habit-Making Unit into the Practice step with an evening calendar reminder by digital Coach Meg to get out the yoga block and do six minutes of the two poses. For now, he keeps the habit in the practice step with daily reminders as he doesn't want to miss out on the pre-bedtime habit. When he is getting ready for his next overnight business trip, Coach Meg reminds him by text to take his yoga block so he can keep up the new bedtime habit.

### Example 3: Fireman Wants to Reduce Sugar Cravings

Dan is a fireman who has a sweet tooth, regularly indulging in mid-morning donuts and ice cream in the evening, which has contributed to a steady gain over 15 years of twenty pounds; it could be worse but it's getting harder for Dan to run fast when he is responding to an emergency. Dan finds it challenging to imagine a donut-free morning and ice-cream free evening given his longstanding habits. He searches the Habit-Making library one evening after enjoying a particularly large bowl of ice cream and finds Dr. Pamela Peeke's Sugar Craving course of 15 habits. The first three habits are free so he downloads them immediately and moves them into the Learn step in his dashboard.

Dan spends a half hour doing the learning step, watching three videos, for all three habits: Craving Surfer, Healthy Breakfast, and Cardio Exercise. He is surprised to learn that just ten minutes of cardio exercise, a quick jog in his neighborhood, could reduce his stress baseline and improve his willpower and appetite for a healthy breakfast. He schedules the Cardio Exercise experiment, which starts with a wake-up alarm on his smartphone and Digital Coach Meg's cheery voice—“Hi Dan, can't wait to hear how the cardio exercise goes this morning. I'll check in after you're done and ask you about breakfast.” Dan jogs around two blocks, and gets back feeling pretty darn good. Digital Coach Meg sends him a text to rate the experiment. He texts back a 5-star rating. After the text exchange, Digital Coach Meg speaks up again from his smartphone: “How about trying a healthy breakfast?” Dan appreciates the nudge and pulls out his wife's chia cereal, adds sliced banana and little almond milk, just as she does, and then takes out two ounces of leftover roast chicken.

At work two hours later his colleague brings in the usual box of donuts for the team. He didn't schedule the Craving Surfer experiment, but he remembers the instructions from the learning video. Breathe deeply and imagine surfing the donut craving as if it is an ocean wave. Gradually the wave of craving peters out. His energy and mood lifts after the surfing experiment, and he is proud of himself for not eating a donut.

That night Dan activates Digital Coach Meg and asks to have her continue the morning wake-up and reminder for three more mornings to see if the benefits continue. Also Dan asks Digital Coach Meg to download the rest of the Sugar Cravings course and sets a reminder to learn about more of the habits before ice cream this evening.

### Example 4: Working Mom Wants to Better Manage Diabetes

Rachel's kids are going off to college and her focus is shifting to her own health, which has taken a second seat to her kids and husband in recent years, along with her mom who has late stage diabetes and Alzheimer's disease. Rachel's blood sugar level is high and a little erratic and her physician has been encouraging her to get more engaged in a healthy lifestyle to prevent the mental and physical decline her mom is experiencing. Her diabetes nurse suggested a Mastering Diabetes Habits course during her last doctor's visit, which is being offered for free by the pharmaceutical company which makes her diabetes medicine. It's a large course with 60 Habits—organized in six sections. Rachel decides to only download the section on Brain Fog with ten Habit-Making Units, as she finds it more and more difficult to stay focused on work projects and has been wondering whether it's related to her diabetes. She impulsively (she is prone to impulsivity) picks three morning habits to learn about, thinking that getting her day off to a good start may be most helpful. Rachel moves the habits into the Learn step in her personal dashboard.

After watching the three habit videos on Sunday afternoon, Rachel moves the three habits into the Experiment step and schedules experiments for Monday, Wednesday, and Friday mornings with a special smartphone ring to prompt her to eat an Oatmeal, Walnuts & Berries breakfast. The funny visual of the dancing walnuts, oats, and berries on her smartphone makes her laugh and she switches from her usual bagel and cream cheese to making oatmeal with walnuts, frozen berries in the microwave. The second experimental habit is to check her brain energy two hours after eating, to learn what best keeps energy high and fog low. She gets a text request asking her to score her brain energy on a scale of 1-10. The first morning her brain energy score is 6; she feels better than after eating a bagel. The second morning after the healthy breakfast her energy score is a 7. The third morning she runs out of time and eats a bagel and is surprised to see how low her brain energy is two hours later: 4 out of 10. Yikes. She decides to move the two healthy breakfast habits to the Practice step in her dashboard. Rachel changes the reminders to prompt her to make the oatmeal and walnuts in the evening to save time in the morning, and include Coach Meg's voice in the morning prompt, energetically encouraging her to eat, and enjoy, the oatmeal, walnuts and berries. The evening and morning reminders keep her on track and she changes the visuals and sounds with the reminders every couple of weeks for variety. Interestingly, she is inspired to skip a before-bedtime cookie and have a few almonds, a surprising side effect of her new habit practices.

Three months later at her next doctor's visit Rachel is happy to report that her energy is better and her blood sugar levels have improved. The nurse is thrilled with the results from making her first two new habits and encourages Rachel to find just one or two more habits to work on next.

### Example 5: College Student Wants to Manage Anxiety

Lisa, a college student, gets hijacked by her worries in what seems to be a random fashion; it can hit any time of day, and day of the week. Her anxious emotions rush her like a thunderstorm and then it's really hard to pay attention to her schoolwork. Her best friend calls her excitedly one day to describe her experience with Digital Coach Meg on her smartphone. Her friend got suggestions of new habits to deal with overwhelm and it's really made a difference.

The next time Lisa experiences an emotional hijack, she connects with digital Coach Meg. “Hello Coach, can you help me. I'm having an attack of anxiety”. “Sure”, says Digital Coach Meg. “There is a suite of 25 habits called Tame Your Frenzy that has excellent ratings for college students. Do you want to download it and check it out?” “Sure”, says Lisa.

Lisa picks four habits to learn about before any experimenting. She first learns about the mindfulness habit where she activates the region of the brain that enables calm self-observation, as though she is watching her anxious self in her life's movie with curiosity, rather than suffering as the anxious actor in the movie. Lisa then learns about the Notice and Name habit, where she notices and names her negative emotions. Third is a self-compassion habit, where you cross your hands over your heart, learning how to suffer well with anxiety. Fourth is a Stretch Away Stress habit, where one does five minutes of stretching on the floor. Lisa decides to experiment with all four as a habit string. She sets them up as an on-demand experiment on her smartphone so she can click to connect with Digital Coach Meg, who will call up all four habit animated icons when needed and walk her through them with her calm, confident voice. In the first week she calls on the four new habits to experiment with on three occasions. Twice she skips the stretching as she feels settled enough to get back to schoolwork after the first three habits.

### OTHER EMBODIMENTS

All publications, patents, and patent applications mentioned in the above specification are hereby incorporated by reference. Various modifications and variations of the described device and methods of use of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention.

Other embodiments are within the claims.

1. An electronic system for facilitating the establishment of one or more habits, said system comprising
a) an electronically-stored library comprising descriptions of multiple habits,
b) a computer for searching said library,
c) a screen for electronically displaying and selecting one or more of the habits that have been selected by a user from said library, and
d) a computer, which can be that of b) or a different computer, for assisting the user in forming the one or more habits selected by the user.

2. The system of claim 1, wherein the habits stored in said library are divided into categories.

3. The system of claim 1, wherein the library comprises at least in part a library accessible to members of the public or accessible to only one organization.

4. The system of claim 1, wherein the library comprises a personal sub-library of habits.

5. The system of claim 2, wherein the publicly-accessible library can be added-to by members of the public.

6. The system of claim 3, wherein the system is configured to allow members of the public to add content to the publicly-accessible library.

7. The system of claim 1, wherein habit formation according to d) comprises at least one of the steps of learning, experimenting, practicing, and sustaining.

8. The system of claim 6, wherein habit formation according to d) further comprises reflecting or social networking or both.

9. The system of claim 7, wherein all four of said steps are employed and at least some of said steps are enabled by computer-generated prompts.

10. The system of claim 9, wherein said prompts are selected from the group consisting of audio, graphic, photo, video, animation, voice, text, and music.

11. The system of claim 1, wherein said computer for assisting in habit formation comprises a digital coach, which can (i) respond to user inquiries, (ii) ask questions and respond to user answers, (iii) offer suggestions, or all of (i), (ii), and (iii).

12. The system of claim 11, wherein said digital coach employs graphics, photos, voice, videos, animation, text or email messages, non-voice audio, an avatar, or music, or a combination thereof.

13. The system of claim 12, wherein the digital coach and the user communicate by voice, the digital coach being programmed to recognize the user's requests and questions and to employ a recorded or computerized voice to respond to the requests and questions.

14. The system of claim 12, wherein the system is programmed to allow the user to request that the digital coach search a Habits Library for a habit that addresses a concern of the user, e.g., procrastination.

15. The system of claim 14, wherein the system is programmed to allow the digital coach to search the Habits Library for said habit and to convey a name or description of the habit to the user.

16. The system of claim 15, wherein the system is programmed to allow the digital coach to instruct the user on one or more of the habit-making steps: learn, experiment, practice, and sustain.

17. The system of claim 16, wherein the learning step comprises presentation of video.

18. The system of claim 16, wherein said instructing comprises audio or visual, or both, of a motivator such as music or an avatar which can talk, in recorded or computerized voice, or display written text.

19. The system of claim 14, wherein the system is programmed to allow the digital coach to prompt the user to do one or more of: a) rate the selected habit, b) decide how to proceed (stop, start, or continue) with respect to the selected habit, c) assess or change one or more motivators with respect to the selected habit, and d) assess the strength of the selected habit.

20. The system of claim 12, wherein the digital coach is programmed for machine learning, such that it changes its prompts, requests, and questions over time after interacting with the user regarding habit-making.

21. The system of claim 20, wherein the digital coach is programmed to apply behavior change techniques to the habit-making process,

22. The system of claim 21, wherein, in employing said behavior change techniques, the digital coach asks the user, by voice or text, to do one or more of the following: a) complete assessments of habit-making boosters such as goals, motivation, confidence, strength, and social support; b) make suggestions based on the assessments of a); c) name a heartfelt intention or benefit of sustaining a particular habit to boost motivation and engagement; d) add user reflections to a digital journal on the process of making one or more habits; and e) engage user's strengths by asking one or more of the coaching questions: what am I curious about?; what would be a creative approach toward making a particular habit?; and how could I enhance my confidence in making a particular habit?

23. The system of claim 1, wherein said system has the capacity to aid multiple users in habit-making, and further has the capacity to amass data from said multiple users, wherein the data comprises identification of habits worked on, success or lack thereof in particular habit formation, and, optionally, demographic information regarding said multiple users.

24. The system of claim 23, wherein the system is configured to analyze said amassed data to assess the popularity or efficacy of strategies for establishing the one or more habits.

25. A method for facilitating the making of one or more habits by one or more users, said method comprising
a) providing an electronically-stored library comprising descriptions of multiple habits,
b) providing a computer for searching said library, whereby said one or more users select one or more habits to establish, and
c) providing at least one human coach to assist the one or more users in forming and/or sustaining said one or more selected habits.

26. The method of claim 25, wherein said selected one or more habits are displayed on a screen.

27. Then method of claim 25, wherein there are multiple users of said method, and wherein said method further comprises d) matching multiple coaches to multiple users.

28. The method of claim 27, wherein the matching is based on pre-determined criteria comprising demographic information about both the users and the coaches.
